(19) United States
(12) Patent Application Publication
(10) Pub. No.: US 2010/0031011 A1
(43) Pub. Date: Feb. 4, 2010

(54) METHOD AND APPARATUS FOR OPTIMIZED METHOD OF BHT BANKING AND MULTIPLE UPDATES

(75) Inventors: Lei Chen, Austin, TX (US); David S. Levitan, Austin, TX (US); David Mui, Round Rock, TX (US); Robert A. Philhower, Valley Cottage, NY (US)

Correspondence Address: Snell & Wilmer L.L.P. (IBM Corp), 600 Anton Blvd, Suite 1400, Costa Mesa, CA, 92626, US

(73) Assignee: INTERNATIONAL BUSINESS MACHINES CORPORATION, Armonk, NY (US)

(21) Appl. No.: 12/185,776

(22) Filed: Aug. 4, 2008

(51) Int. Cl. G06F 9/30

(52) U.S. Cl. 712/240; 712/E09.016

(57) ABSTRACT

The invention relates to a method and apparatus for controlling the instruction flow in a computer system and more particularly to the predicting of outcome of branch instructions using branch prediction arrays, such as BHTs. In an embodiment, the invention allows concurrent BHT read and write accesses without the need for a multi-ported BHT design, while still providing comparable performance to that of a multi-ported BHT design.

### CROSS REFERENCE TO RELATED APPLICATION

This application is related to application entitled “Method and Apparatus for Updating a Branch History Table Using an Update Table” filed on an even date herewith and bearing Ser. No. 12/166,108, filed Jul. 1, 2008, the invention of which is incorporated herein in entirety for background information.

### BACKGROUND

1. Field of the Invention

The disclosure generally relates to the control of instruction flow in a computer system, and more particularly to the prediction of branch instructions using branch prediction arrays.

2. Description of Related Art

A microprocessor implemented with a pipelined architecture enables the microprocessor to have multiple instructions in various stages of execution per each clock cycle. In particular, a microprocessor with a pipelined, superscalar architecture can fetch multiple instructions from memory and dispatch multiple instructions to various execution units within the microprocessor. Thus, the instructions are executed simultaneously and in parallel.

A problem with such an architecture is that the program being executed often contains branch instructions, which are machine-level instructions that transfer to another instruction, usually based on a condition. The transfers occur only if a specific condition is true or false. When a branch instruction encounters a data dependency, rather than stalling instruction issue until the dependency is resolved, the microprocessor predicts which path the branch instruction is likely to take, and instructions are fetched and executed along that path. When the data dependency is available for resolution of the aforementioned branch, the branch is evaluated. If the predicted path was correct, program flow continues along that path uninterrupted; otherwise, the processor backs up, and program flow resumes along the correct path.

In modern microprocessors, a branch predictor is used to determine whether a conditional branch in the instruction flow of a program is likely to be taken or not. This is called branch prediction. Branch predictors are critical in today's modern, superscalar processors for achieving high performance. They allow processors to fetch and execute instructions without waiting for a branch to be resolved.

Branch prediction via branch prediction array(s), such as branch history table(s) or BHT(s), allows an initial branch instruction to be guessed from the prediction bits. Later, branch instructions are issued from a branch queue to the branch execution unit. When a branch is executed, a determination is made as to whether the branch instruction was correctly predicted or not. Depending on the value of the prediction bits and the branch outcome, the new prediction bits are updated accordingly.

The problem with conventional processors, such as in the high-end PowerPC family of processors manufactured by International Business Machines, Inc., is that the prediction array can only perform a single read or write operation per cycle since the array has only one port.

One solution to the problem associated with having a single port is executing an array write cycle arbitrate with an instruction fetch address register control logic is to add a read “hole” to allow the write cycle to update the array. This process holds fetching of instructions and is not efficient in a multi-threaded microprocessor core.

Another solution to this problem is to add a separate write port to the prediction array. However, the addition of a separate write port is costly in terms of processor space and power consumption, especially when multiple arrays are included in a single microprocessor core.

Thus, there is a need for an improved method of concurrent read and write cycle accesses without using a multi-ported array design.

### SUMMARY

In one embodiment, the invention relates to a method of performing a concurrent read and write access to a branch prediction array, such as a BHT, with a single port in a multi-threaded processor. A method of performing a concurrent read and write access to a branch prediction array with a single port in a multi-threaded processor, the method comprising: retrieving an instruction address from an instruction fetch address register, the instruction address used to access an instruction cache; retrieving an instruction from the instruction cache using the branch address; identifying a bank conflict if a read address and a write address contain a same subset of lower address bits and a concurrent read request and write request exists; retrieving a set prediction bits from the branch prediction array; scanning the instruction retrieved from the instruction cache to determine if the instruction is a branch, for a branch instruction, defining the branch instruction as one of a conditional branch instruction or an unconditional branch instruction; transferring the branch address, the branch instruction, prediction bits, and a conditional branch indicator to a branch execution unit; executing the branch instruction; performing a write update to the branch prediction array, the write update writing to the branch prediction array in X consecutive cycles if the prediction branch results in a correct prediction, and the write update writing to the branch prediction array in Y consecutive cycles if the prediction branch results in an incorrect prediction, the branch prediction array checking for bank conflicts against the concurrent read request; preempting an older branch update if a younger branch update is executed in a next consecutive cycle, wherein the step of identifying a bank conflict includes allowing the read request priority if the conflict exists, and allowing both the read request and the write request if a conflict does not exist. The number of updates, X and Y, can be predetermined or be set dynamically. The multiple updates allow more opportunities for the write to be successful in the event of a bank address conflict.

### BRIEF DESCRIPTION OF THE DRAWINGS

These and other embodiments of the invention will be discussed with reference to the following non-limiting and exemplary illustrations, in which like elements are numbered similarly, and where:

FIG. 1 depicts a block diagram representation of a microprocessor chip within a data processing system;

FIG. 2 is a block diagram of an illustrative embodiment of a processor having a branch prediction mechanism in accordance with an embodiment of the present invention; and

FIG. 3 is a flowchart illustrating the process of updating the branch prediction array, which can be a BHT, in accordance with an exemplary method and system of the present invention.

### DETAILED DESCRIPTION

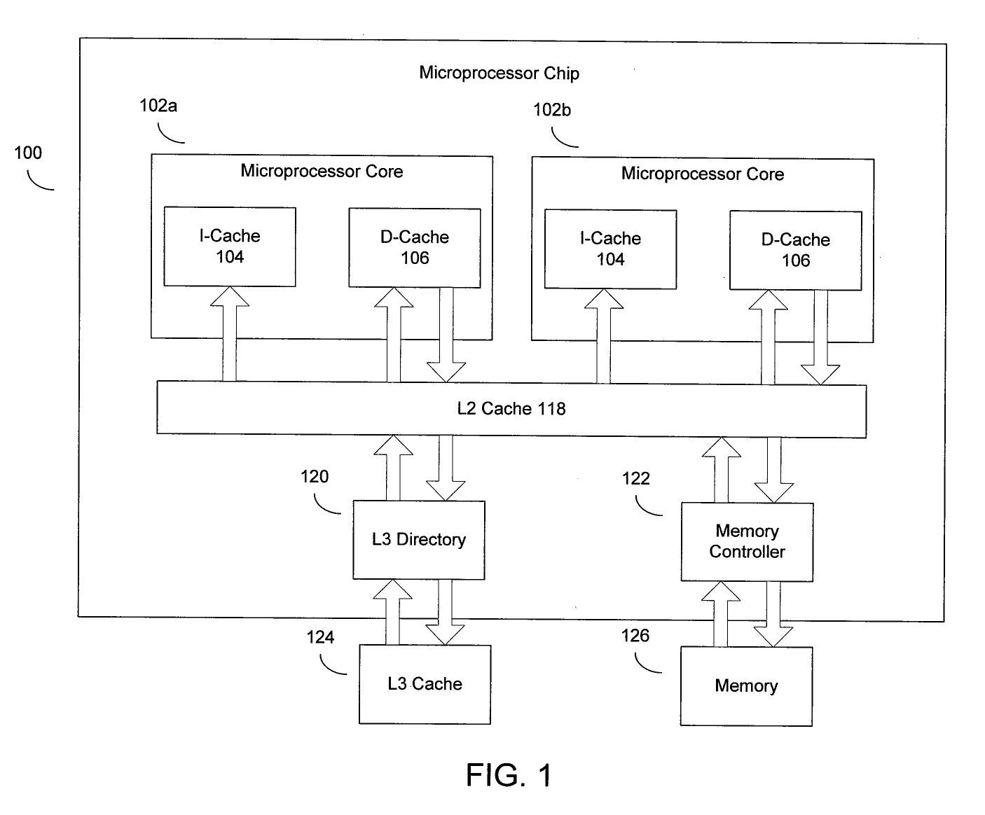

With reference now to the figures, FIG. 1 depicts a block diagram representation of a microprocessor chip within a data processing system. Microprocessor chip 100 comprises microprocessor cores 102a, 102b. Microprocessor cores 102a, 102b utilize instruction cache (I-cache) 104 and data cache (D-cache) 106 as a buffer memory between external memory and microprocessor cores 102a, 102b. I-cache 104 and D-cache 106 are level 1 (L1) caches, which are coupled to share level 2 (L2) cache 118. L2 cache 118 operates as a memory cache, external to microprocessor cores 102a, 102b. L2 cache 118 is coupled to memory controller 122. Memory controller 122 is configured to manage the transfer of data between L2 cache 118 and main memory 126. Microprocessor chip 100 may also include level 3 (L3) directory 120. L3 directory 120 provides on chip access to off chip L3 cache 124. L3 cache 124 may be additional dynamic random access memory.

Those of ordinary skill in the art will appreciate that the hardware and basic configuration depicted in FIG. 1 may vary. For example, other devices/components may be used in addition to or in place of the hardware depicted. The depicted example is not meant to imply architectural limitations with respect to the present invention.

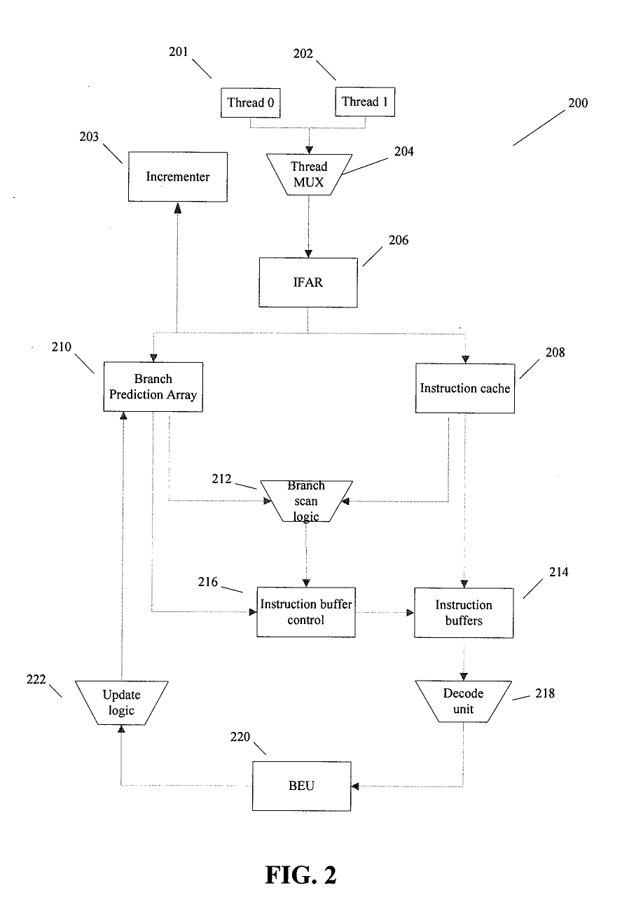

FIG. 2 is a block diagram of an illustrative embodiment of a processor having a branch prediction mechanism in accordance with an embodiment of the present invention. The multi-threaded processor 100 may be any known central processing unit (e.g., a PowerPC processor made by IBM).

As illustrated, multi-threaded processor 200 may include multiple threads 201 and 202 or a single thread. Thread multiplexer 204 may be used to select which thread to start fetching from. The size of multiplexer 204 may be directly proportional to the number of threads. In an embodiment of the present invention, a four threaded instruction fetch design (N=3) is used, where 0 corresponds to the first thread, and N corresponds to the last thread.

Thread multiplexer 204 selects a new fetch address from thread 201. The output of thread multiplexer 204 is a virtual fetch address that identifies the location of the next instruction or group of instructions that multi-threaded processor 200 should execute. The fetch address is latched by instruction fetch address register (IFAR) 206 and forwarded to instruction cache 208 and branch prediction arrays such as a branch prediction array 210. In an embodiment, branch prediction array 210 may be a branch history table (BHT). Instruction cache 208 returns one or more instructions that are later retrieved by instruction control buffers 214 as described below. Incrementer 202 is used to increment the instruction address for a particular thread. In the event of a taken branch instruction, the branch target address is loaded back to the thread 201.

Branch prediction array 210 is accessed for obtaining branch predictions using the address from IFAR 206. Branch prediction array 210 is preferably a bimodal branch history table which is accessed by using a selected number of bits taken directly from a fetch address or a hashed fetch address with global history. Furthermore, a person of ordinary skill would also understand that multiple branch prediction mechanisms, such as local branch prediction and global branch prediction, may be combined using the principles of the present invention, and such embodiments would be within the spirit and scope of the present invention.

Branch scan logic 212 decodes a subset of bits from Instruction cache 208 and determines which instructions are branches. Branch instructions detected by branch scan logic 212 are paired with a “taken” or “not taken” branch prediction from branch prediction array 210, and are then routed by branch scan logic 212 according to the type of branch instruction to instruction buffer control 216.

When a branch instruction is received by instruction buffer control 216, instruction buffer control 216, it marks where the branch is relative to instructions from Instruction cache 208. The Instruction buffers 214 simply store the instructions from Instruction cache 208. The appropriate number of instruction buffers will vary according to the particular type of processor and application, and such variation is within the ordinary level skill in the art.

The branch instruction from instruction buffers 214 is routed to decode unit 218. Decode unit 218 decodes and dispatches the branch instruction to branch execution unit (BEU) 220. During the execute stage, BEU 220 executes sequential instructions received from decode unit 218 opportunistically as operands and execution resources for the indicated operations become available.

After execution of the branch instruction by BEU 220, a branch outcome is known and that information is used by update logic 222. The update logic 222 is configured to update branch prediction array 210 upon detection of an executed conditional branch instruction. Update logic 222 then writes branch prediction array 210 if required. If a bank conflict does not exist (described in more detail below), then a write update to branch prediction array 210 will be successful. Update logic 222 performs X consecutive write attempts to branch prediction array 210 if the branch prediction was correct. If the branch prediction was mispredicted, update logic 222 performs Y consecutive write attempts to branch prediction array 210. The values for X and Y can be predetermined or set dynamically. Update logic 222 does not write branch prediction array 210 if the BHT bit value is saturated, for example 00→00, or 11→11; that is, if the BHT bit value remains the same.

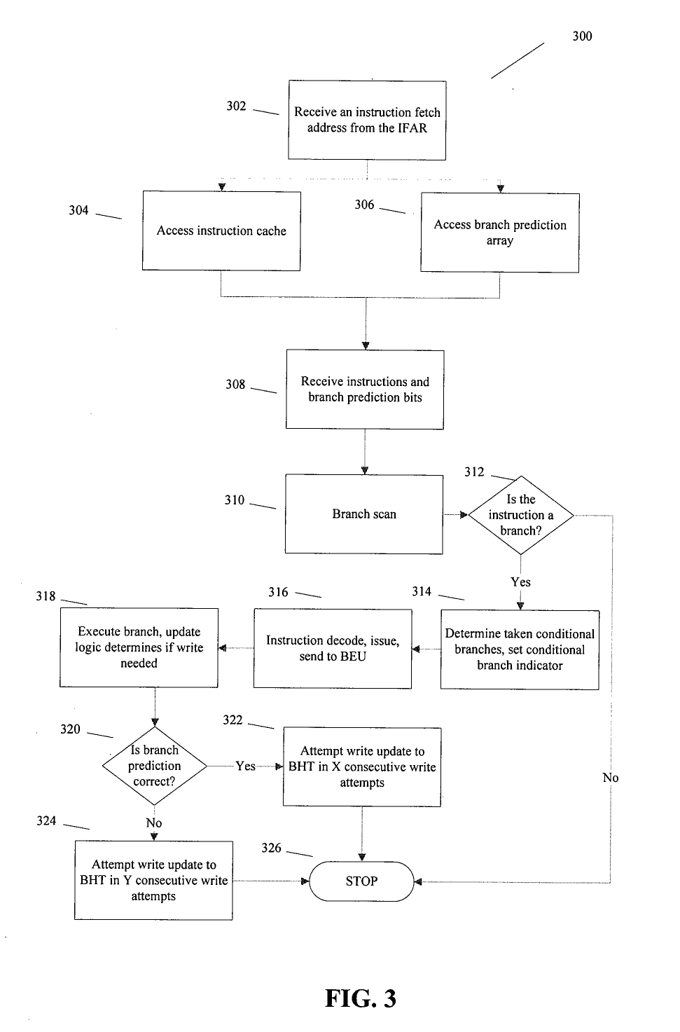

FIG. 3 is a flowchart illustrating the process of updating the branch prediction array in accordance with the method and system of the present invention. Those skilled in the art will appreciate from the following description that although the steps comprising the flowchart are illustrated in a sequential order, many of the steps illustrated in FIG. 3 can be performed concurrently or in an alternative order.

Referring concurrently to FIG. 2 and FIG. 3 simultaneously, process 300 begins at step 302 in response to retrieving an instruction fetch address from IFAR 206. The process proceeds from step 302 to steps 304 and 306. At step 304, the instruction address is used to access instruction cache 208. At step 306, the instruction address or hashed address are used to access the branch prediction array, where a bank conflict is identified. A bank conflict exists if the read address and the write address both contain the same subset of lower address bits and there are concurrent read and write requests. In the case of a bank conflict, the read is given priority and the write is dropped.

The process then proceeds step 308, where instructions and branch prediction bits are received. Instruction cache 208 returns one or more instructions, which are then retrieved by instruction buffers 214.

The process then proceeds step 310, where branch scan logic 212 receives a subset of the output by instruction cache 208. In step 312, branch scan logic 112 determines which instructions are branches. If an instruction is a branch, the process then proceeds to step 314. If the instruction is not a branch, the process terminates.

The process then proceeds to step 314, where the taken conditional branches are determined, and the conditional branch indicator is set. In step 316, the instructions are decoded, and the branch address, the branch instruction, the prediction bits, and a conditional branch indicator are transferred to BEU 220. The conditional branch indicator is used to indicate to BEU 220 and Update logic 222 that the branch is conditional. The branch instruction is executed at step 318 at which time the branch outcome is known, which is used to determine if the original branch prediction was correct or not and the update logic 222 determines if an update is required. The process then proceeds to step 320, where a determination is made as to whether or not the branch prediction is correct.

If the branch prediction was correct, the process proceeds to step 322, where update logic 222 may perform X consecutive write attempts to branch prediction array 210. If the branch prediction was mispredicted, the process proceeds to step 324, where update logic 222 may perform Y consecutive write attempts to branch prediction array 210. In an embodiment of the invention, branch prediction array 210 is a branch history table as stated above.

In an embodiment of the invention, the write update is preempted if a younger branch update is executed in a next consecutive cycle. It is important to note that during the write updates, the branch prediction arrays are also checking for bank conflicts if there is a concurrent read request. The purpose of the multiple update attempts is to ensure the write completes successfully. The process stops at step 326.

While the specification has been disclosed in relation to the exemplary and non-limiting embodiments provided herein, it is noted that the inventive principles are not limited to these embodiments and include other permutations and deviations without departing from the spirit of the invention.

1. A method of performing a concurrent read and write access to a branch prediction array with a single port in a multi-threaded processor, the method comprising:
retrieving an instruction address from an instruction fetch address register, the instruction address used to access an instruction cache;
retrieving an instruction from the instruction cache using the instruction address;
identifying a bank conflict if a read address and a write address contain a same subset of lower address bits and a concurrent read request and write request exist exists;
retrieving a set of prediction bits from the branch prediction array;
scanning the instruction retrieved from the instruction cache to determine if the instruction is a branch branch instruction and defining the branch instruction as one of a conditional branch instruction or an unconditional branch instruction;
transferring a branch address, the branch instruction, the set of prediction bits, and a conditional branch indicator to a branch execution unit;
executing the branch instruction;
attempting a write update to the branch prediction array, the write update writing to the branch prediction array in X consecutive cycles if the prediction branch results in a correct prediction, and the write update writing to the branch prediction array in Y consecutive cycles if the prediction branch results in an incorrect prediction, the branch prediction array checking for bank conflicts against the concurrent read request;
preempting an older branch update if a younger branch update is executed in a next consecutive cycle,
wherein the step of identifying a bank conflict includes granting the read request priority if the conflict exists, and allowing both the read request and the write request if a conflict does not exist.
